(19) United States
(12) Patent Application Publication
(10) Pub. No.: US 2011/0141045 A1
(43) Pub. Date: Jun. 16, 2011

(54) MOBILE TERMINAL HAVING MULTIPLE TOUCH PANELS AND OPERATION METHOD FOR THE SAME

(75) Inventors: Hyong Uk CHOI, Seoul (KR); Sung Wook KANG, Seoul (KR)

(73) Assignee: SAMSUNG ELECTRONICS CO. LTD., Suwon-si (KR)

(21) Appl. No.: 12/965,193

(22) Filed: Dec. 10, 2010

(30) Foreign Application Priority Data
Dec. 10, 2009 (KR) 10-2009-0122316

(51) Int. Cl. G06F 3/041

(52) U.S. Cl. 345/173

(57) ABSTRACT

A mobile terminal having multiple touch panels and a touch panel operating method for the same are provided. A single touch controller is employed to control multiple touch panels. The mobile terminal includes a first touch panel disposed at one side and comprising at least one touch sensor, a second touch panel disposed at another side and comprising at least one touch sensor, and a touch controller having a plurality of ports, wherein at least one of the plurality of ports is connected to a touch sensor in the first touch panel and at least one of the plurality of ports other than the port connected to the first touch panel is connected to a touch sensor in the second touch panel, and wherein the touch controller conducts scanning on the first touch panel and second touch panel to recognize a touch.

### PRIORITY

This application claims the benefit under 35 U.S.C. §119(a) of a Korean patent application filed on Dec. 10, 2009 in the Korean Intellectual Property Office and assigned Serial No. 10-2009-0122316, the entire disclosure of which is hereby incorporated by reference.

### BACKGROUND OF THE INVENTION

1. Field of the Invention

The present invention relates to a mobile terminal having multiple touch panels. More particularly, the present invention relates to a mobile terminal that controls multiple touch panels using a single touch controller and to an operation method for the same.

2. Description of the Related Art

With rapid popularization, mobile terminals have become a necessity of modern life. In particular, many users favor touch-enabled mobile terminals employing touch sensor technology. Recently, mobile terminals having a double-sided touch capability have been developed to extend the touch-based user interface.

A mobile terminal having a double-sided touch capability includes one touch panel at the front and another touch panel at the back. When the user performs a touch action, the mobile terminal recognizes a user input by sensing a touch point on the touch panels at the front and back. In such a touch sensing process, a touch controller is employed for touch panel control. The mobile terminal may require two touch controllers to control the two touch panels. Use of two touch panels may extend the functionality of the mobile terminal in terms of user interface features. However, having to provide two touch controllers increases manufacturing costs of the mobile terminal In addition, as the central processing unit of the mobile terminal has to control the two touch controllers, a processing burden thereof is increased.

### SUMMARY OF THE INVENTION

An aspect of the present invention is to address at least the above-mentioned problems and/or disadvantages and to provide at least the advantages described below. Accordingly, an aspect of the present invention is to provide a mobile terminal having multiple touch panels that can be manufactured at low cost.

Another aspect of the present invention is to provide a mobile terminal having multiple touch panels that can reduce data processing burden of the central processing unit.

Another aspect of the present invention is to provide a touch panel operating method for the mobile terminal having multiple touch panels.

In accordance with an exemplary embodiment of the present invention, a mobile terminal is provided. The terminal includes a first touch panel disposed at one side of the mobile terminal and comprising at least one touch sensor, a second touch panel disposed at another side of the mobile terminal and comprising at least one touch sensor, and a touch controller having a plurality of ports, wherein at least one of the plurality of ports is connected to a touch sensor in the first touch panel and at least one of the plurality of ports other than the port connected to the first touch panel is connected to a touch sensor in the second touch panel, and wherein the touch controller conducts scanning on the first touch panel and second touch panel to recognize a touch on the first touch panel or second touch panel.

In accordance with another exemplary embodiment of the present invention, a touch panel operating method for a mobile terminal having first and second touch panels is provided. The method includes receiving a command for executing an application in the mobile terminal, identifying pattern information on a sensor arrangement pattern corresponding to the application to be executed, changing a sensor arrangement pattern of at least one of the first touch panel and the second touch panel according to the identified pattern information, and conducting scanning on the first touch panel and second touch panel in a specific sequence according to the changed sensor arrangement pattern.

According to an aspect of the present invention, a mobile terminal is provided. The mobile terminal includes a first touch panel having at least one touch sensor, a second touch panel having at least one touch sensor, a single touch controller for controlling the first touch panel and the second touch panel and including a plurality of ports connected to at least one of the first touch panel and the second touch panel, wherein a first group of the plurality of ports is connected to at least one of the touch sensor(s) of the first touch panel and a second group of the plurality of ports is connected to at least one of the touch sensor(s) of the second panel, and wherein the first group and the second group each include at least one port, and no port in the first group is included in the second group.

According to an aspect of the present invention, it is possible to manufacture mobile terminals having multiple touch panels at low cost. It is also possible to reduce processing load of the central processing unit when operating multiple touch panels.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates the front and back of a mobile terminal having two touch panels according to an exemplary embodiment of the present invention;

FIG. 2A is a block diagram of a mobile terminal having two touch panels according to an exemplary embodiment of the present invention;

FIG. 2B illustrates the structure of a touch panel according to an exemplary embodiment of the present invention;

FIG. 3A illustrates the structure of a control unit together with first and second touch panels according to an exemplary embodiment of the present invention;

FIG. 3B illustrates a sensor arrangement pattern for the first and second touch panels together with a touch controller according to an exemplary embodiment of the present invention;

FIGS. 4A to 4D illustrate different sensor arrangement patterns for the first and second touch panels according to an exemplary embodiment of the present invention;

FIG. 5A illustrates the structure of a control unit together with first and second touch panels according to an exemplary embodiment of the present invention;

FIG. 5B illustrates a sensor arrangement pattern for the first and second touch panels together with a touch controller and a switch array according to an exemplary embodiment of the present invention;

FIG. 6 is a flowchart of a touch panel operating method for the control unit in FIG. 5A according to an exemplary embodiment of the present invention;

FIG. 7 illustrates a switch configuration for changing a sensor arrangement pattern according to an exemplary embodiment of the present invention; and

FIG. 8 illustrates a switch configuration for changing a sensor arrangement pattern according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding, but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not to be limited to the bibliographical meanings, but are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The description of exemplary embodiments of the present invention is focused on a mobile terminal. However, exemplary embodiments of the present invention are not limited thereto, and are applicable to any touch-enabled device. A mobile terminal according to an exemplary embodiment of the present invention is a touch-enabled terminal, and may include a mobile communication terminal, a Portable Multimedia Player (PMP), a Personal Digital Assistant (PDA), a smart phone, or an MP3 player. The mobile communication terminal may include an International Mobile Telecommunications 2000 (IMT 2000) terminal, Wideband Code Division Multiple Access (WCDMA) terminal, Global System for Mobile Communications (GSM)/General Packet Radio Services (GPRS) terminal, or Universal Mobile Telecommunications System (UMTS) terminal.

The following description is focused on a mobile terminal having two touch panels. However, exemplary embodiments of the present invention are not limited thereto, and are applicable to a mobile terminal having more than two touch panels.

According to an exemplary embodiment of the present invention, one of the two touch panels is installed at the front of the mobile terminal, and the other touch panel is installed at the back of the mobile terminal. A mobile terminal according to an exemplary embodiment of the present invention may include a transparent display feature, which enables the finger touching the front of the mobile terminal to be seen from the back.

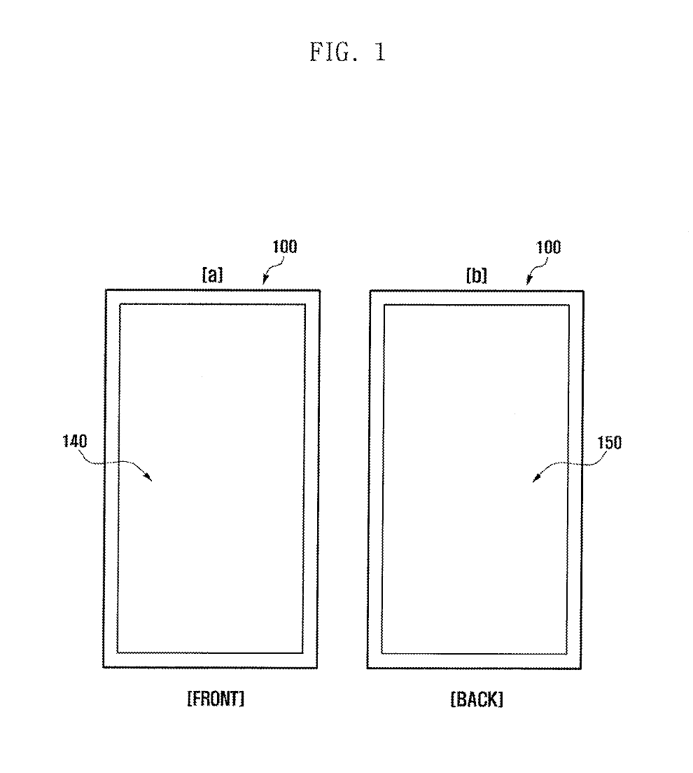

FIG. 1 illustrates the front and back of a mobile terminal having two touch panels according to an exemplary embodiment of the present invention.

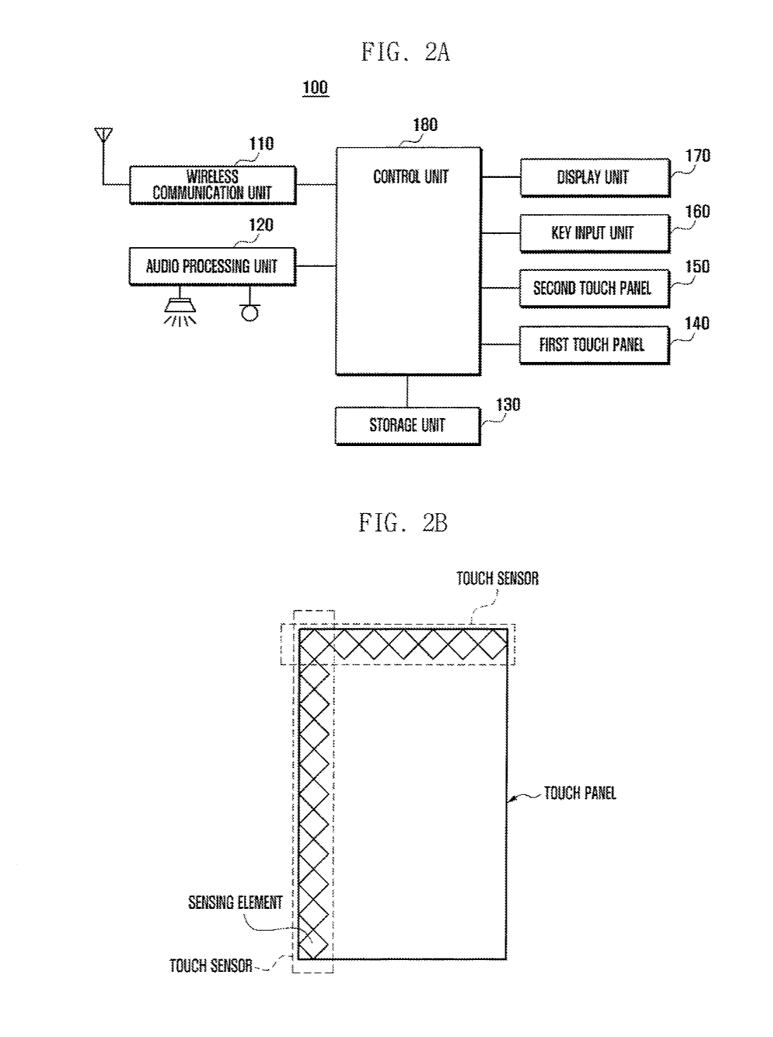

Referring to FIG. 1, reference symbol [a] indicates the front side of a mobile terminal 100, on which a first touch panel 140 is installed. The first touch panel 140 may cover a whole or part of the front side of the mobile terminal 100. A key input unit 160 (shown in FIG. 2A) may be installed on a part of the front side not covered by the first touch panel 140. Reference symbol [b] indicates the back side of the mobile terminal 100, on which a second touch panel 150 is installed. Components of the mobile terminal 100 are described in connection with FIGS. 2A and 2B.

FIG. 2A is a block diagram of a mobile terminal having two touch panels according to an exemplary embodiment of the present invention.

Referring to FIG. 2A, the mobile terminal 100 includes a wireless communication unit 110, an audio processing unit 120, a storage unit 130, the first touch panel 140, the second touch panel 150, the key input unit 160, a display unit 170, and a control unit 180.

The wireless communication unit 110 sends and receives data for wireless communication of the mobile terminal 100. The wireless communication unit 110 may include a radio frequency transmitter for upconverting the frequency of a signal to be transmitted and amplifying the signal, and a radio frequency receiver for low-noise amplifying a received signal and downconverting the frequency of the signal. The wireless communication unit 110 may receive data through a wireless channel and forward the received data to the control unit 180, and may transmit data from the control unit 170 through the wireless channel.

The audio processing unit 120 may include a coder/decoder (codec). The codec includes a data codec for processing packet data, and an audio codec for processing an audio signal such as a voice signal. The audio processing unit 120 converts a digital audio signal into an analog signal through the audio codec to reproduce the analog signal through a speaker, and also converts an analog audio signal from a microphone into a digital audio signal through the audio codec.

Each of the first touch panel 140 and second touch panel 150 recognizes user touch, and includes one or more touch sensors. The touch sensors generate a touch signal corresponding to user touch and send the touch signal to the control unit 180. The touch sensors may be realized using capacitive, resistive, infrared, pressure sensors, and the like. Any sensor capable of detecting contact or pressure may be utilized as a touch sensor.

Each of the first touch panel 140 and second touch panel 150 includes one or more touch sensors arranged in specific directions. One touch sensor is composed of multiple sensing elements arranged in one or more rows in a specific direction. In one exemplary embodiment, a touch sensor may be composed of a single sensing element. In another exemplary embodiment, sensing elements arranged in a row along the vertical direction may constitute a single touch sensor, and sensing elements arranged in a row along the horizontal direction may constitute a single touch sensor. Each of the first touch panel 140 and second touch panel 150 is composed of combinations of touch sensors.

FIG. 2B illustrates a structure of a first touch panel or a second touch panel according to an exemplary embodiment of the present invention.

Referring to FIG. 2B, sensing elements arranged in a row along the vertical direction or the horizontal direction constitute a single touch sensor. A touch panel may include multiple touch sensors.

In one exemplary embodiment, the first touch panel 140 or the second touch panel 150 may be composed of a single touch sensor. The arrangement pattern of touch sensors included in the first touch panel 140 or the second touch panel 150 may be configured according to desired patterns of touch inputs. The sum of the number of touch sensors included in the first touch panel 140 and the number of touch sensors included in the second touch panel 150 may be less than or equal to the number of ports in a touch controller 182.

The storage unit 130 stores programs and data necessary for the operation of the mobile terminal 100, and may include a program area and a data area. The storage unit 130 may be composed of volatile storage media, non-volatile storage media, or a combination thereof. The volatile storage media may include semiconductor memories such as Random Access Memory (RAM), Dynamic RAM (DRAM), and Static RAM (SRAM), and the non-volatile storage media may include a hard disk, etc. According to an exemplary embodiment of the present invention, the storage unit 130 stores an application program for touch panel operation and information regarding sensor arrangement patterns. A sensor arrangement pattern denotes an arrangement pattern of touch sensors constituting the first touch panel 140 or the second touch panel 150.

The key input unit 160 generates a key signal corresponding to user manipulation and sends the key signal to the control unit 180. The key input unit 160 may include a keypad including alphanumeric, direction, and function keys. When the mobile terminal 100 can be fully manipulated through the first touch panel 140 and the second touch panel 150, the key input unit 160 may be omitted from the mobile terminal 100.

The display unit 170 may be realized using Liquid Crystal Display (LCD) devices. The display unit 170 visually provides various information to the user, including menus, input data, and function-setting data. For example, the display unit 170 may output a boot screen, an idle screen, a call handling screen, and other application screens for the mobile terminal 100. The display unit 170 together with at least one of the first touch panel 140 and the second touch panel 150 may constitute a touch screen.

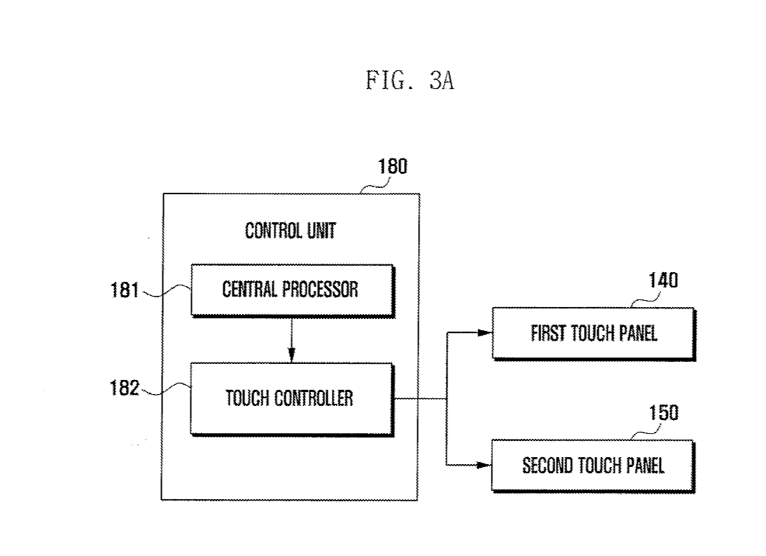

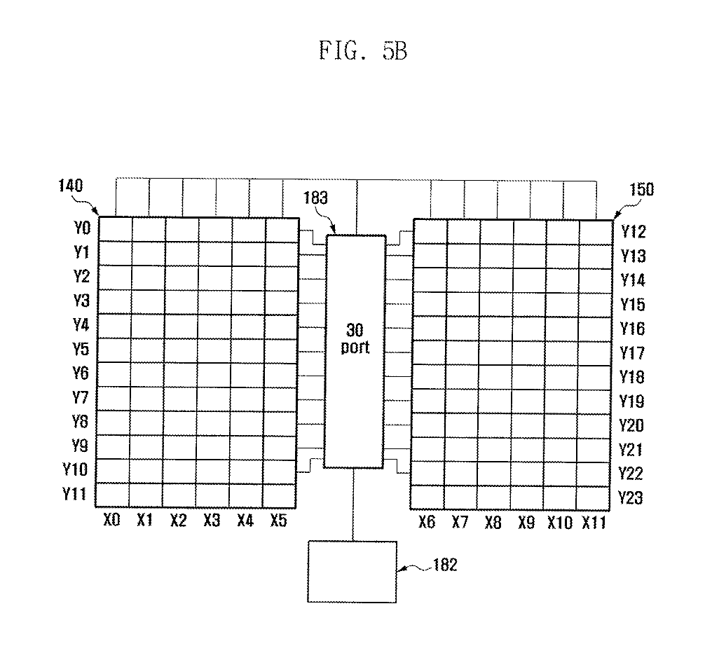

The control unit 180 controls the overall operation of the components of the mobile terminal 100. The control unit 180 performs an operation in response to user touch on the first touch panel 140 or the second touch panel 150. The structure of the control unit 180 may be varied according to configurability of the sensor arrangement pattern in the first touch panel 140 or the second touch panel 150. For example, one exemplary embodiment of the control unit 180 is shown in FIG. 3A, and another exemplary embodiment thereof is shown in FIG. 5A.

FIG. 3A illustrates a structure of a control unit together with first and second touch panels according to an exemplary embodiment of the present invention.

Referring to FIG. 3A, the control unit 180 includes a central processor 181 and a touch controller 182. The central processor 181 controls the overall operation of the mobile terminal 100, and may be composed of a modem chip. The central processor 181 controls the components of the mobile terminal 100 illustrated in FIG. 2A, and controls the touch controller 182 described below.

The touch controller 182 controls the first touch panel 140 and the second touch panel 150. According to an exemplary embodiment of the present invention, a single touch controller 182 is included in the control unit 180. The touch controller 182 includes a plurality of ports, which are connected with touch sensors in the first touch panel 140 and second touch panel 150. In one exemplary embodiment, one port may be connected to one touch sensor. In another exemplary embodiment, one port may be connected to multiple touch sensors.

According to an exemplary embodiment of the present invention, the sum of the number of touch sensors included in the first touch panel 140 and the number of touch sensors included in the second touch panel 150 may be less than or equal to the number of ports in the touch controller 182. The sensor arrangement pattern of the first touch panel 140 and second touch panel 150 and the number of ports in the touch controller 182 may be determined so as to satisfy the above condition.

The touch controller 182 conducts scanning on the first touch panel 140 and second touch panel 150 in a particular sequence. The touch controller 182 may scan the first touch panel 140 first and then scan the second touch panel 150, or may scan the second touch panel 150 first and then scan the first touch panel 140. As used herein, scanning denotes reading data from the ports. The ports of the touch controller 182 are connected with touch sensors in the first touch panel 140 and second touch panel 150, and the touch controller 182 periodically reads the ports. When the user does not touch the first touch panel 140 or the second touch panel 150, the touch controller 182 obtains a default port value through scanning as the touch sensors do not generate electrical sensing signals. When the user touches the first touch panel 140 or the second touch panel 150, the touch controller 182 obtains a distinct port value through scanning as a corresponding touch sensor generates an electrical sensing signal, and computes the coordinates of the touched point using the obtained port value.

According to an exemplary embodiment of the present invention, the touch controller 182 treats the first touch panel 140 and the second touch panel 150 as one. In other words, the touch controller 182 scans the first touch panel 140 and the second touch panel 150 in a single process by regarding the first touch panel 140 and the second touch panel 150 as a single touch panel.

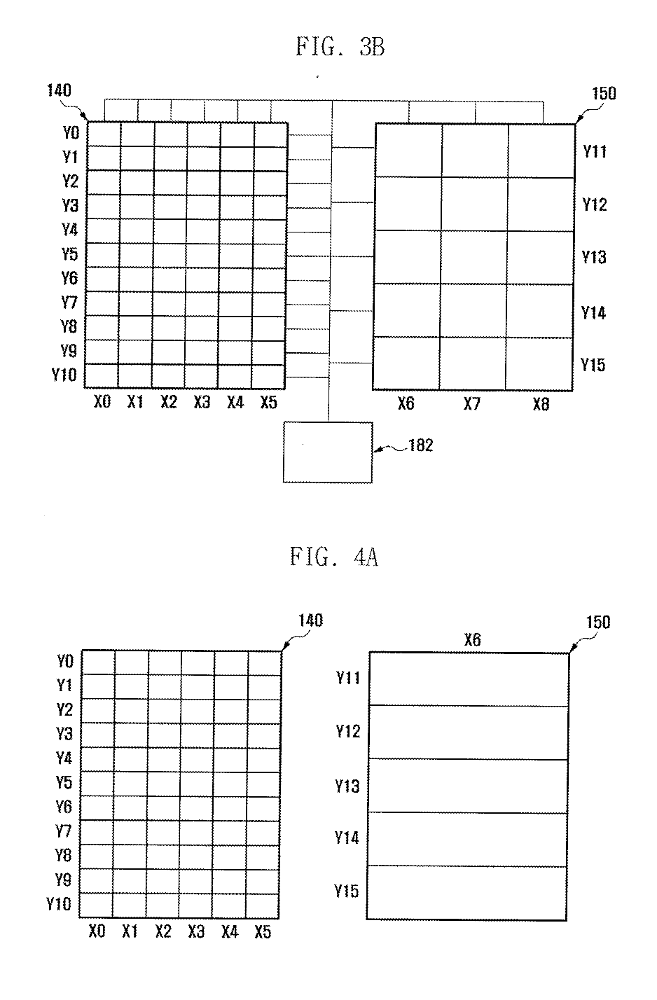

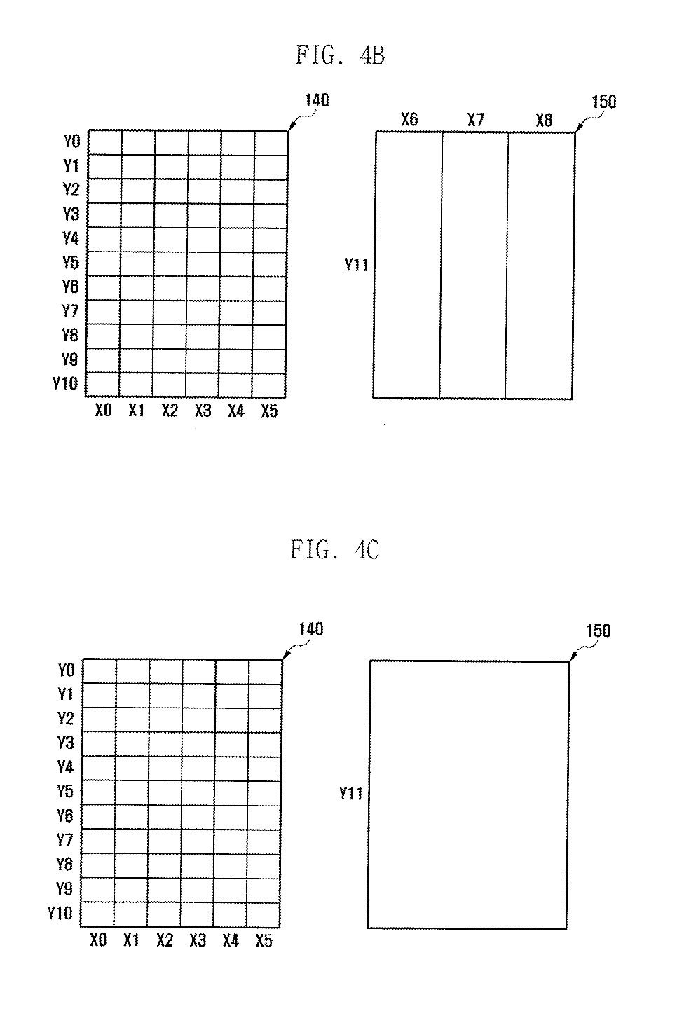

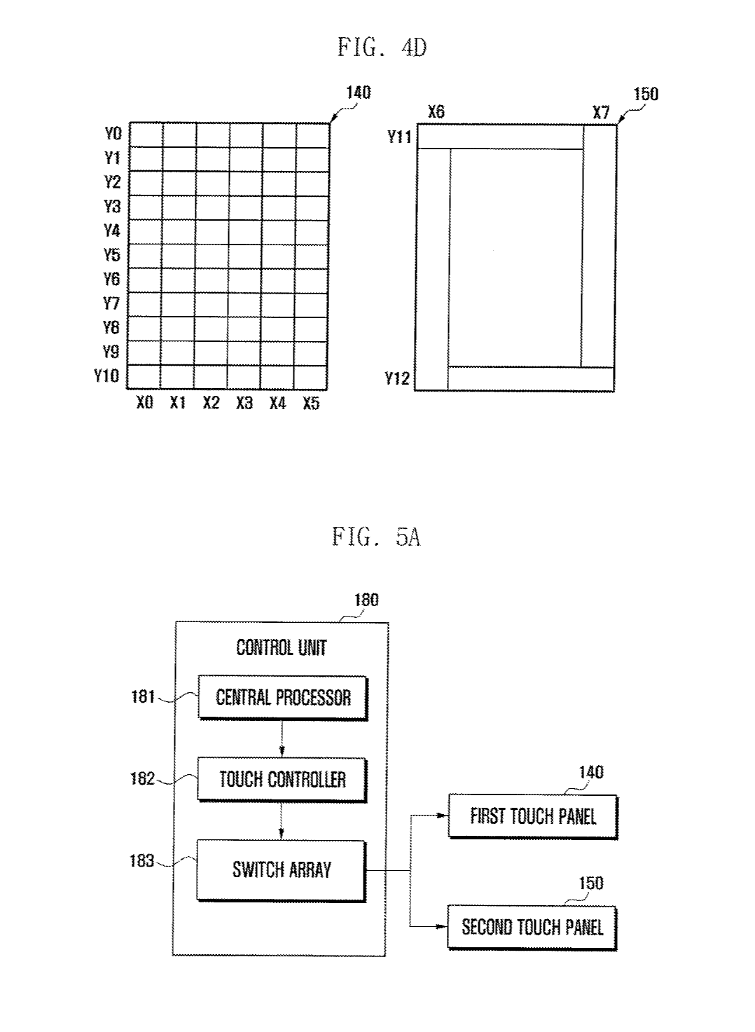

The first touch panel 140 or the second touch panel 150 is composed of a combination of touch sensors whose sensing elements are arranged in a row along the horizontal direction and touch sensors whose sensing elements are arranged in a row along the vertical direction. Examples of this arrangement are shown in FIGS. 3B and 4A-4D. Sensing elements of the touch sensors on a horizontal line are arranged along the vertical direction, and sensing elements of the touch sensors on a vertical line are arranged in the horizontal direction.

The touch controller 182 may scan touch sensors of the first touch panel 140 and the second touch panel 150 on a row-first basis. For example, the touch controller 182 may conduct scanning from the first row of the first touch panel 140 to the last row thereof, from the first row of the second touch panel 150 to the last row thereof, from the first column of the first touch panel 140 to the last column thereof, and finally from the from the first column of the second touch panel 150 to the last column thereof. Alternatively, the touch controller 182 may scan touch sensors of the first touch panel 140 and the second touch panel 150 on a column-first basis. Multiple touch sensors included the first touch panel 140 and the second touch panel 150 may be arranged in various patterns. As used herein, “sensor arrangement pattern” denotes an arrangement pattern of touch sensors included in the first touch panel 140 and the second touch panel 150.

FIG. 3B illustrates a sensor arrangement pattern for first and second touch panels together with a touch controller according to an exemplary embodiment of the present invention.

Referring to FIG. 3B, the first touch panel 140 is composed of touch sensors Y0 to Y10 and touch sensors X0 to X5. Each of the touch sensors Y0 to Y10 includes six sensing elements arranged in a row in the horizontal direction. Each of the touch sensors X0 to X5 includes eleven sensing elements arranged in a row in the vertical direction. The touch sensors Y0 to Y10 may be disposed at a layer different from that of the touch sensors X0 to X5.

In FIG. 3B, the second touch panel 150 is composed of touch sensors Y11 to Y15 and touch sensors X6 to X8. Each of the touch sensors Y11 to Y15 includes three sensing elements arranged in a row in the horizontal direction. Each of the touch sensors X6 to X8 includes five sensing elements arranged in a row in the vertical direction. The touch sensors Y11 to Y15 may be disposed at a different layer than the touch sensors X6 to X8.

Touch sensors in the first touch panel 140 and the second touch panel 150 are connected with ports of the touch controller 182. Although the ports of the touch controller 182 are directly connected with touch sensors, these connections are simplified in FIG. 3B.

In FIG. 3B, the touch controller 182 is connected with 11 touch sensors Y0 to Y10, 6 touch sensors X0 to X5, 5 touch sensors Y11 to Y15 and 3 touch sensors X6 to X8. The number of ports in the touch controller 182 (i.e., the total number of touch sensors in the first touch panel 140 and second touch panel 150) may be greater than or equal to 25.

The touch controller 182 may scan the touch sensors Y0 to Y10 first, scan the touch sensors Y11 to Y15, scan the touch sensors X0 to X5, and finally scan the touch sensors X6 to X8. Alternatively, the touch controller 182 may scan the touch sensors X0 to X5 first, scan the touch sensors X6 to X8, scan the touch sensors Y0 to Y10, and finally scan the touch sensors Y11 to Y15.

In FIG. 3B, as the number of touch sensors in the first touch panel 140 is greater than that in the second touch panel 150, the touch controller 182 can more precisely determine the coordinates of touch points on the first touch panel 140 than in the second touch panel 150. The sensor arrangement pattern for the first touch panel 140 and the second touch panel 150 in FIG. 3B may be applied to an application that requires more precise touch points on the first touch panel 140 and less precise touch point coordinates on the second touch panel 150.

FIGS. 4A to 4D illustrate different sensor arrangement patterns for first and second touch panels according to an exemplary embodiment of the present invention.

Referring to FIG. 4A, the first touch panel 140 is composed of touch sensors Y0 to Y10 and touch sensors X0 to X5, and the second touch panel 150 is composed of touch sensors Y11 to Y15 and a touch sensor X6. The first touch panel 140 may be the same as the first touch panel 140 in FIG. 3B. The touch controller 182 treats touches sensed by a single touch sensor as the same touch input.

For example, different touch points in a zone covered by the touch sensor Y11 may be regarded as the same by the touch controller 182. This is also applied to each of the touch sensors Y12 to Y15. The sensor arrangement pattern for the first touch panel 140 and the second touch panel 150 in FIG. 4A may be applied to an application that requires precise touch point coordinates for the first touch panel 140 and distinguishes several touch zones in the vertical direction (for example, top, top/middle, middle, middle/bottom and bottom) on the second touch panel 150.

Referring to FIG. 4B, the first touch panel 140 is composed of touch sensors Y0 to Y10 and touch sensors X0 to X5, and the second touch panel 150 is composed of a touch sensor Y11 and touch sensors X6 to X8. The first touch panel 140 may be the same as the first touch panel 140 in FIG. 3B. The touch controller 182 treats touches sensed by a single touch sensor as the same touch input.

The sensor arrangement pattern for the first touch panel 140 and the second touch panel 150 in FIG. 4B may be applied to an application that requires precise touch point coordinates for the first touch panel 140 and distinguishes several touch zones in the left-right direction (for example, left, middle and right) on the second touch panel 150.

Referring to FIG. 4C, the first touch panel 140 is composed of touch sensors Y0 to Y10 and touch sensors X0 to X5, and the second touch panel 150 is composed of a single touch sensor Y11. The first touch panel 140 is the same as the first touch panel 140 in FIG. 3B. The touch controller 182 treats touches sensed by a single touch sensor as the same touch input. The sensor arrangement pattern for the first touch panel 140 and the second touch panel 150 in FIG. 4C may be applied to an application that requires precise touch point coordinates for the first touch panel 140 and checks only touch generation for the second touch panel 150.

Referring to FIG. 4D, the first touch panel 140 is composed of touch sensors Y0 to Y10 and touch sensors X0 to X5, and the second touch panel 150 is composed of touch sensors Y11 and Y12 and touch sensors X6 and X7. The first touch panel 140 may be the same as the first touch panel 140 in FIG. 3B.

The second touch panel 150 has touch sensors near the border. The touch sensor Y11 is placed on a top horizontal line, the touch sensor Y12 is placed on a bottom horizontal line, the touch sensor X6 is placed on a left vertical line, and the touch sensor X7 is placed on a right vertical line.

In most cases, when the user grips the mobile terminal 100, a touch is generated at the border thereof. Accordingly, touch sensors placed near the border of the mobile terminal 100 may indicate whether the mobile terminal 100 is gripped by the user. The sensor arrangement pattern for the first touch panel 140 and the second touch panel 150 in FIG. 4D may be applied to an application that requires precise touch point coordinates for the first touch panel 140 and determines whether the mobile terminal 100 is gripped by the user based on touch points sensed by the second touch panel 150.

A description is provided above of the configuration of a mobile terminal with a fixed sensor arrangement pattern for the first touch panel and second touch panel. A mobile terminal supporting a double-sided touch capability tends to require precise touch point coordinates on only one of the two touch panels. In such a case, realization of a double-sided touch capability using a single touch controller may lower manufacturing costs. Additionally, use of the single touch controller may reduce a processing burden of the central processor and heighten a processing speed thereof. A description of a mobile terminal 100 with a configurable sensor arrangement pattern for the first touch panel 140 and the second touch panel 150 is provided below.

FIG. 5A illustrates a structure of a control unit together with first and second touch panels according to another exemplary embodiment of the present invention.

Referring to FIG. 5A, the control unit 180 includes a central processor 181, a touch controller 182, and a switch array 183. The central processor 181 controls the overall operation of the mobile terminal 100, and controls the touch controller 182 in particular.

The touch controller 182 controls the first touch panel 140 and the second touch panel 150. According to an exemplary embodiment of the present invention, a single touch controller 182 is included in the control unit 180. The touch controller 182 includes a plurality of ports, which are connected with touch sensors in the first touch panel 140 and second touch panel 150 through the switch array 183. The touch controller 182 conducts scanning on the first touch panel 140 and second touch panel 150 in a particular sequence.

The switch array 183 is designed to selectively connect the ports of the touch controller 182 with the touch sensors in the first touch panel 140 and second touch panel 150. Under the control of the touch controller 182, the switch array 183 may combine two or more touch sensors in the first touch panel 140 or the second touch panel 150 into a single touch sensor or may block selected connections between some ports of the touch controller 182 and some touch sensors in the first touch panel 140 or the second touch panel 150. The switch array 183 changes the sensor arrangement pattern of the first touch panel 140 and the second touch panel 150 by selectively connecting the ports and the touch sensors.

FIG. 5B illustrates a sensor arrangement pattern for first and second touch panels together with a touch controller and a switch array according to an exemplary embodiment of the present invention.

Referring to FIG. 5B, the first touch panel 140 is composed of touch sensors Y0 to Y11 and touch sensors X0 to X5. Each of the touch sensors Y0 to Y11 includes six sensing elements arranged in a row along the horizontal direction. Each of the touch sensors X0 to X5 includes twelve sensing elements arranged in a row along the vertical direction. The touch sensors Y0 to Y11 may be disposed at a layer different from that of the touch sensors X0 to X5.

In FIG. 5B, the second touch panel 150 is composed of touch sensors Y12 to Y23 and touch sensors X6 to X11. Each of the touch sensors Y12 to Y23 includes six sensing elements arranged in a row along the horizontal direction. Each of the touch sensors X6 to X11 includes twelve sensing elements arranged in a row along the vertical direction. The touch sensors Y12 to Y23 may be disposed at a layer different from that of the touch sensors X6 to X11.

The touch sensors in the first touch panel 140 and the second touch panel 150 are connected to the switch array 183, and the switch array 183 connects the touch sensors and the ports of the touch controller 182. The switch array 183 may connect touch sensors in the first touch panel 140 and the second touch panel 150 to the ports of the touch controller 182 while excluding some of the touch sensors, or may connect two or more touch sensors with one port.

In FIG. 5B, the first touch panel 140 includes 12 touch sensors Y0 to Y11 and 6 touch sensors X0 to X5, and the second touch panel 150 includes 12 touch sensors Y12 to Y23 and 6 touch sensors X6 to X11. When the touch controller 182 includes 30 ports, the ports cannot be connected with all the touch sensors in the first touch panel 140 and the second touch panel 150 on a one-to-one basis, because the number of touch sensors is greater than the number of ports. In such a case, the switch array 183 enables the touch controller 182 to control the first touch panel 140 and second touch panel 150 using 30 ports by connecting two or more touch sensors to one port or blocking connections between some touch sensors and ports. This corresponds to changing the sensor arrangement pattern for the first touch panel 140 and second touch panel 150. The sensor arrangement pattern may be changed according to the application running on the mobile terminal 100 or user settings.

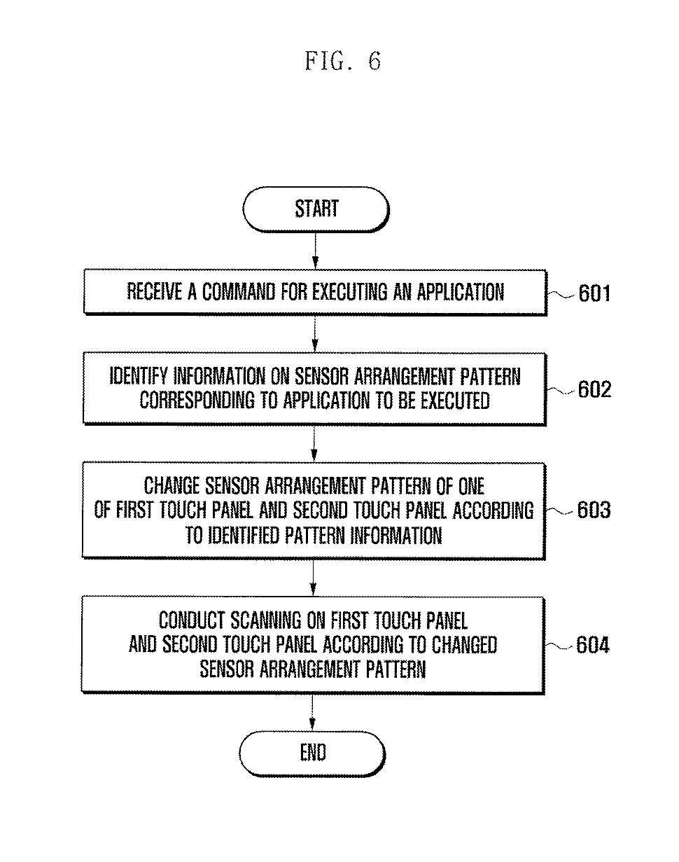

FIG. 6 is a flowchart of a touch panel operating method for a control unit according to an exemplary embodiment of the present invention. The storage unit 130 of the mobile terminal 100 stores an application and information on the related sensor arrangement pattern.

Referring to FIG. 6, the control unit 180 of the mobile terminal 100 receives a command for executing an application in step 601. When the user enters an application execution command through the first touch panel 140, the second touch panel 150 or the key input unit 160, the first touch panel 140, the second touch panel 150 or the key input unit 160 generates a corresponding input signal and sends the input signal to the control unit 180.

The control unit 180 retrieves information on the sensor arrangement pattern corresponding to the application from the storage unit 130 in step 602. The storage unit 130 may pre-store information regarding associations between sensor arrangement patterns (as in FIGS. 4A to 4D) and applications.

The touch controller 182 of the control unit 180 controls the switch array 183 to adjust the sensor arrangement pattern of the first touch panel 140 or the second touch panel 150 according to the retrieved pattern information in step 603. For example, the touch controller 182 may connect two or more touch sensors with one port or block connections between some touch sensors and ports.

The touch controller 182 conduct scanning on the first touch panel 140 and second touch panel 150 according to the adjusted sensor arrangement pattern in step 604. The touch controller 182 may scan the first touch panel 140 first and then scan the second touch panel 150, or scan the second touch panel 150 first and then scan the first touch panel 140. The touch controller 182 may scan the touch sensors in the first touch panel 140 and the second touch panel 150 on a row-first basis or on a column-first basis.

As described above, by changing the sensor arrangement pattern according to an application, both the first touch panel 140 and the second touch panel 150 can be controlled through the single touch controller 182, and the user can be provided with an optimal touch environment.

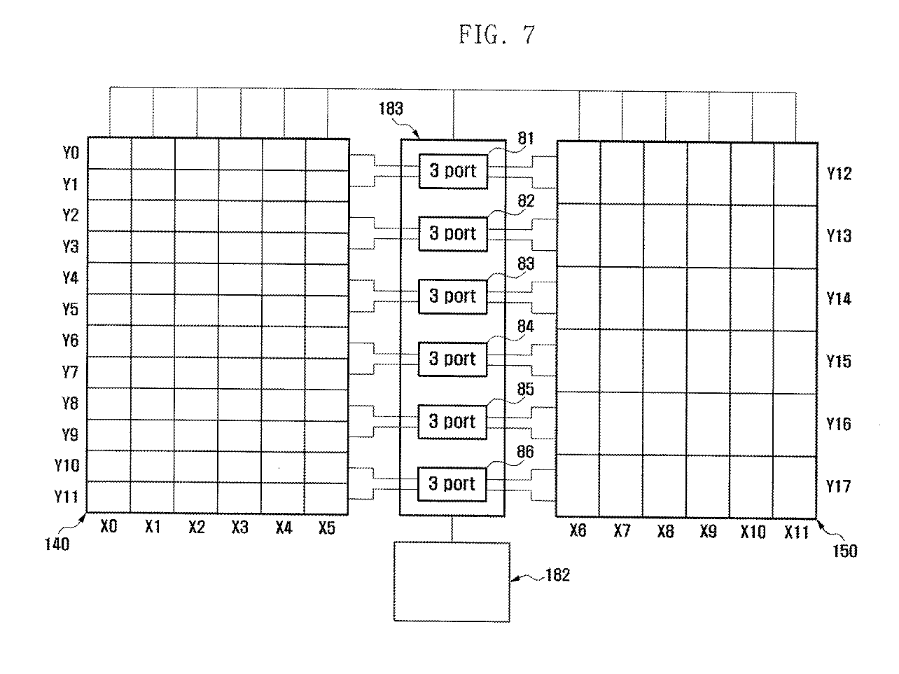

FIG. 7 illustrates a switch configuration for changing a sensor arrangement pattern according to an exemplary embodiment of the present invention. It is assumed that the sensor arrangement pattern in FIG. 5B is changed to the sensor arrangement pattern in FIG. 7.

Referring to FIG. 7, the switch array 183 includes six switches 81 to 86, each of which connects three ports with touch sensors. Each of the switches 81 to 86 is connected with four touch sensors (as shown in FIG. 5B). For example, the switch 81 is connected with touch sensors Y0, Y1, Y12 and Y13 (as shown in FIG. 5B). As only three ports are assigned to the switch 81, the switch 81 cannot connect the three ports with the four touch sensors on a one-to-one basis. Hence, the switch 81 connects at least two touch sensors with one port. Assuming that the sensor arrangement pattern corresponding to an application to be executed indicates that the first touch panel 140 is composed of 12 touch sensors on horizontal lines and 6 touch sensors on vertical lines and the second touch panel 150 is composed of 6 touch sensors on horizontal lines and 6 touch sensors on vertical lines, the touch controller 182 controls the switch array 183 to combine each pair of touch sensors on adjacent horizontal lines into one touch sensor. The two combined touch sensors have sensing elements arranged on two adjacent horizontal lines.

As shown in FIG. 7, the touch controller 182 controls the switch array 183 so that the second touch panel 150 includes six touch sensors on horizontal lines. The switch 81 combines touch sensors Y12 and Y13 (as shown in FIG. 5B) into a touch sensor Y12 (as shown in FIG. 7). Similarly, the switches 82 to 86 produce touch sensors Y13 to Y17, respectively, through sensor combination.

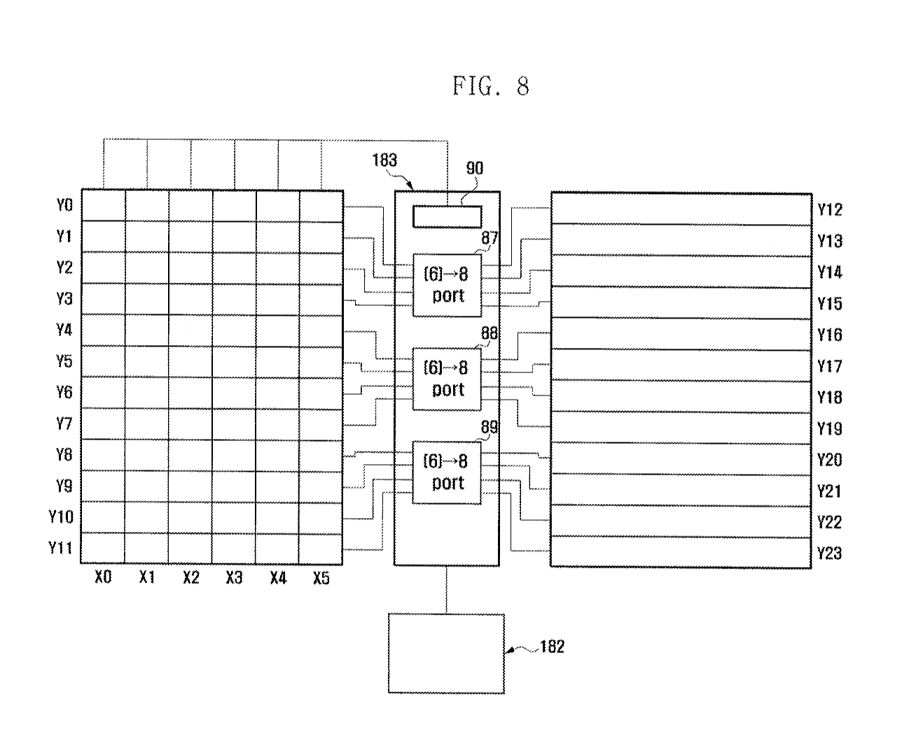

FIG. 8 illustrates another switch configuration for changing a sensor arrangement pattern according to an exemplary embodiment of the present invention. It is assumed that the sensor arrangement pattern in FIG. 5B is changed to the sensor arrangement pattern in FIG. 8.

Referring to FIG. 8, the switch array 183 includes three switches 87 to 89 connecting 6 to 8 ports with touch sensors, and a switch 90 connecting ports with touch sensors on vertical lines. Each of the switches 87 to 89 is set to connect touch sensors with 6 ports. Each of the switches 87 to 89 is connected with 8 touch sensors in FIG. 5B. The switch 87 is connected with touch sensors Y0 to Y3 and Y12 to Y15 in FIG. 5B. As the switch 87 is assigned 6 ports, the switch 87 cannot directly connect 8 touch sensors in all with 6 ports. Under the control of the touch controller 182, the switch 90 may connect all touch sensors on vertical lines in the first touch panel 140 and second touch panel 150 with ports, connect all touch sensors on vertical lines in the first touch panel 140 with ports, or connect all touch sensors on vertical lines in the second touch panel 150 with ports.

For example, assume that the sensor arrangement pattern corresponding to an application to be executed indicates that the first touch panel 140 is composed of 12 touch sensors on horizontal lines and 6 touch sensors on vertical lines and the second touch panel 150 is composed of 12 touch sensors on horizontal lines. The touch controller 182 controls the switch 90 to block connections between touch sensors on vertical lines in the second touch panel 150 and ports of the touch controller 182. The touch controller 182 increases the number of assigned ports from 6 to 8 for the switches 87 to 89. This serves to assign more ports to touch sensors on horizontal lines in the second touch panel 150 by not assigning ports to touch sensors on vertical lines. The touch controller 182 controls the switches 87 to 89 so that all touch sensors on horizontal lines in the second touch panel 150 are connected with ports.

The touch panel operating method according to an exemplary embodiment of the present invention may be implemented as computer programs and may be stored in various computer readable storage media. The computer readable storage media may store program instructions, data files, data structures, and combinations thereof. The program instructions may include instructions developed specifically for the present invention and existing general-purpose instructions.

The computer readable storage media includes a variety of physical media, including magnetic media, such as a hard disk and floppy disk; optical media, such as a Compact Disc (CD) and Digital Versatile Disc (DVD); magneto-optical media such as a floptical disk; and memory devices such as a Read Only Memory (ROM) and RAM. The program instructions may include machine codes produced by compilers and high-level language codes executable through interpreters.

While the invention has been described with reference to certain exemplary embodiments thereof, it will be understood by those skilled in the art, that various changes in form and details may be made therein without departing from the spirit and scope of the invention as defined in the appended claims and their equivalents.

What is claimed is:

1. A mobile terminal comprising:
a first touch panel disposed at one side of the mobile terminal and comprising at least one touch sensor;
a second touch panel disposed at another side of the mobile terminal and comprising at least one touch sensor; and
a touch controller having a plurality of ports,
wherein at least one of the plurality of ports is connected to a touch sensor in the first touch panel and at least one of the plurality of ports other than the port connected to the first touch panel is connected to a touch sensor in the second touch panel, and
wherein the touch controller conducts scanning on the first touch panel and second touch panel to recognize a touch on the first touch panel or second touch panel.

2. The mobile terminal of claim 1, wherein the touch sensor is one of a horizontal touch sensor having multiple sensing elements arranged in a row along the horizontal direction and a vertical touch sensor having multiple sensing elements arranged in a row along the vertical direction.

3. The mobile terminal of claim 2, wherein each of the first touch panel and the second touch panel comprise horizontal touch sensors arranged in the vertical direction and vertical touch sensors arranged in the horizontal direction.

4. The mobile terminal of claim 3, wherein the touch controller scans, in order, horizontal touch sensors in the first touch panel, horizontal touch sensors in the second touch panel, vertical touch sensors in the first touch panel, and vertical touch sensors in the second touch panel.

5. The mobile terminal of claim 3, wherein the touch controller scans, in order, vertical touch sensors in the first touch panel, vertical touch sensors in the second touch panel, horizontal touch sensors in the first touch panel, and horizontal touch sensors in the second touch panel.

6. The mobile terminal of claim 2, wherein a size of a sensing element in the second touch panel is greater than a size of a sensing element in the first touch panel.

7. The mobile terminal of claim 2, wherein the second touch panel comprises two horizontal touch sensors placed near the top end and the bottom end, and two vertical touch sensors placed near the left end and the right end.

8. The mobile terminal of claim 2, wherein the second touch panel comprises a single touch sensor.

9. The mobile terminal of claim 3, further comprising:
a switch array for relaying connections between at least one touch sensor in the first touch panel or the second touch panel and ports of the touch controller.

10. The mobile terminal of claim 9, wherein the touch controller controls the switch array to change the arrangement pattern of at least one touch sensor included in the first touch panel or the second touch panel.

11. The mobile terminal of claim 10, wherein the switch array combines two or more touch sensors into a single touch sensor.

12. The mobile terminal of claim 10, wherein the switch array blocks all or some connections between ports of the touch controller and at least one touch sensor in the first touch panel or second touch panel.

13. A touch panel operating method for a mobile terminal having first and second touch panels, the method comprising:
receiving a command for executing an application in the mobile terminal;
identifying pattern information on a sensor arrangement pattern corresponding to the application to be executed;
changing a sensor arrangement pattern of at least one of the first touch panel and the second touch panel based on the identified pattern information; and
conducting scanning on the first touch panel and second touch panel in a specific sequence according to the changed sensor arrangement pattern.

14. The method of claim 13, wherein the changing of the sensor arrangement pattern comprises combining two or more touch sensors in the first touch panel or the second touch panel into a single touch sensor.

15. The method of claim 13, wherein the changing of the sensor arrangement pattern comprises blocking all or some connections between ports of a touch controller and at least one touch sensor in the first touch panel or second touch panel.

16. A mobile terminal comprising:
a first touch panel having at least one touch sensor;
a second touch panel having at least one touch sensor;
a single touch controller for controlling the first touch panel and the second touch panel and including a plurality of ports connected to at least one of the first touch panel and the second touch panel,
wherein a first group of the plurality of ports is connected to at least one of the touch sensor(s) of the first touch panel and a second group of the plurality of ports is connected to at least one of the touch sensor(s) of the second panel, and
wherein the first group and the second group each include at least one port, and no port in the first group is included in the second group.

17. The mobile terminal of claim 16, wherein the total number of the touch sensors in the first touch panel and the second touch panel is less than or equal to the number of ports in the single touch controller.

18. The mobile terminal of claim 16, wherein the total number of the touch sensors in the first touch panel and the second touch panel is greater than the number of ports in the single touch controller.

19. The mobile terminal of claim 16, further comprising:
a switch array for connecting the touch sensors of the first touch panel and the second touch panel to the plurality of ports of the single touch controller.

20. The mobile terminal of claim 19, wherein the switch array blocks at least one connection between a touch sensor of the first touch panel or the second touch panel and a port of the single touch controller based on a sensor arrangement pattern.
